(19) United States
(12) Patent Application Publication
(10) Pub. No.: US 2026/0103232 A1
(43) Pub. Date: Apr. 16, 2026

(54) STEER-BY-WIRE STEERING DEVICE, POWER SUPPLY SYSTEM AND VEHICLE INCLUDING THE SAME

(71) Applicant: HL MANDO CORPORATION, Gyeonggi-do (KR)

(72) Inventors: Taesik KIM, Gyeonggi-do (KR); Taeyun KOO, Gyeonggi-do (KR); Jaehoon BAE, Gyeonggi-do (KR); Kyuyeong JE, Gyeonggi-do (KR)

(21) Appl. No.: 19/340,843

(22) Filed: Sep. 25, 2025

(30) Foreign Application Priority Data
Oct. 15, 2024 (KR) 10-2024-0140652

(51) Int. Cl. B62D 5/00; H02J 9/06

(52) U.S. Cl. CPC B62D 5/003; B62D 5/006; H02J 9/061

(57) ABSTRACT

A power supply system for supplying power to a steer-by-wire steering system supplies power to a steer-by-wire steering system including a main system and an auxiliary system, and may include a high voltage power supply, a converter converting a voltage of the high voltage power supply into an operating voltage, a low voltage power supply, and an uninterruptible power supply configured to receive power from the low voltage power supply and supply power to the auxiliary system.

### CROSS REFERENCE TO RELATED APPLICATION

This application claims priority from Korean Patent Application No. 10-2024-0140652, filed on Oct. 15, 2024, which is hereby incorporated by reference for all purposes as if fully set forth herein.

### TECHNICAL FIELD

An embodiment of the present disclosure relates to a steer-by-wire steering device, a power supply system and a vehicle including the same.

### BACKGROUND

A electric steering device may drive a motor using an electronic control unit (ECU) according to the vehicle's driving conditions so as to provide a light and comfortable steering feel at low speeds, a heavy steering feel and good directional stability at high speeds, and rapid steering in emergency situations, thereby providing the driver with optimal steering conditions.

The slectric steering device may include an electro-hydraulic power steering (EHPS) device, a motor driven power steering (MDPS) device, and an electric power steering (EPS) device. Unlike hydraulic systems forming hydraulic pressure from a pump to assist power, electric steering systems have a structure of assisting steering power with the rotational force of a motor.

Recently, there has been proposed a steer-by-wire system capable of eliminating the mechanical connection between a steering wheel and the driven wheels of a vehicle. The steer-by-wire system can steer the vehicle by receiving the steering wheel's rotation signal through an electronic control unit (ECU) and operating the motor connected to the driven wheels.

Since there is no mechanical connection between the steering wheel and the driven wheels in the steer-by-wire system, stability is very important. In particular, related technologies for the steer-by-wire system are required to enable safe steering of the vehicle in various situations.

### SUMMARY

Embodiments of the present disclosure are to provide a steer-by-wire steering and power supply technology.

In accordance with an aspect of the present disclosure, there may be provided a power supply system for supplying power to a steer-by-wire steering device including a main system and an auxiliary system, the power supply system, including a high voltage power supply, a converter configured to convert a voltage of the high voltage power supply into an operating voltage, a low voltage power supply, and an uninterruptible power supply configured to receive power from the low voltage power supply and supply the power to the auxiliary system of the steer-by-wire steering device.

In accordance with another aspect of the present disclosure, there may be provided a steer-by-wire steering device including a main system including a steering reaction motor configured to provide a steering reaction force and a first steering motor configured to provide a steering force, an auxiliary system including a steering angle sensor configured to detect a steering angle of a steering wheel and a second steering motor configured to provide the steering force, and a controller configured to control the main system and the auxiliary system, wherein the main system is configured to receive an operating voltage from a low voltage power supply or a converter configured to convert a voltage of a high voltage power supply to the operating voltage, and the auxiliary system is configured to receive the operating voltage from an uninterruptible power supply device configured to receive power from the low voltage power supply.

In accordance with an aspect of the present disclosure, there may be provided a vehicle including a high voltage power supply, a motor configured to receive power from the high voltage power supply, a converter configured to convert a voltage of the high voltage power supply into an operating voltage, a low voltage power supply, a steer-by-wire steering device including a main system and an auxiliary system, and an uninterruptible power supply configured to receive power from the low voltage power supply and supply the power to the auxiliary system of the steer-by-wire steering device.

The present embodiments may provide a power supply technique for a steer-by-wire steering device.

### BRIEF DESCRIPTION OF THE DRAWINGS

FIG. 1 schematically illustrates a steer-by-wire steering device to which the present embodiments can be applied.

FIG. 2 is a diagram for explaining the operation of the steer-by-wire steering device.

FIG. 3 is a diagram for explaining a power supply system according to one embodiment.

FIG. 4 is a diagram for explaining a power supply system according to another embodiment.

FIG. 5 is a diagram for explaining a configuration of a steer-by-wire steering device according to another embodiment.

FIG. 6 is a diagram for explaining a vehicle configuration according to another embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

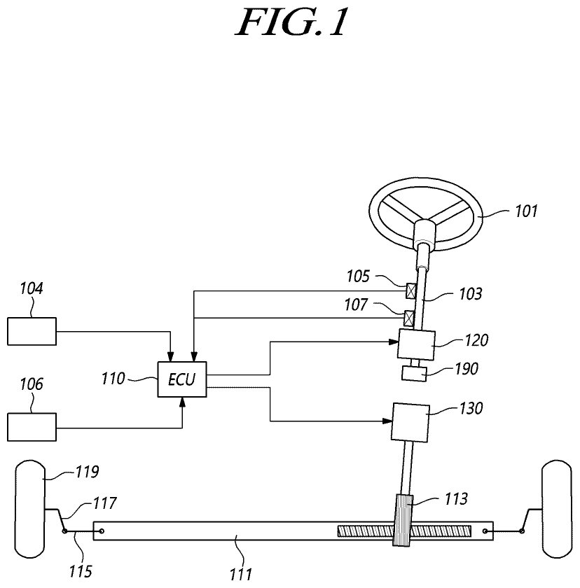

FIG. 1 schematically illustrates a steer-by-wire steering device to which the present embodiments can be applied.

Referring to FIG. 1, a steer-by-wire steering device according to the present embodiments may be configured such that an angle sensor 105 and a torque sensor 107 are coupled to one side of a steering shaft 103 connected to a steering wheel 101, and when the driver operates the steering wheel 101, the angle sensor 105 and the torque sensor 107 detect a steering angle and a toque and transmit electric signals to an electronic control device 110 so that a steering shaft motor 120 and a pinion shaft motor 130 are operated.

The electronic control device 110 controls the steering shaft motor 120 and the pinion shaft motor 130 based on the electric signals transmitted from the angle sensor 105 and the torque sensor 107 and the electric signals transmitted from various sensors mounted on the automobile.

The steering shaft motor 120 is connected to a reducer 145 that reduces the rotational speed of the motor, and during normal driving, the steering shaft motor provides a reaction force to the steering shaft 103 so as for a driver to feel a steering reaction force in the opposite direction when the driver operates the steering wheel 101. In addition, during autonomous driving, steering is performed by the control of the electronic control device 110 without the intervention of the driver's intention.

The pinion shaft motor 130 slides a rack bar 111 connected to a pinion shaft 113 to steer the wheels 119 on both sides through a tie rod 115 and a knuckle arm 117.

However, in the drawings of the present embodiments, for convenience of explanation, it is illustrated as an example in which an angle sensor 105 and a torque sensor 107 provided on the steering shaft 103, a vehicle speed sensor 104 for transmitting steering information to the electronic control device 110, and a pinion shaft rotation angle sensor 106 are provided. However, a motor position sensor, various radars and lidars, and image sensors such as cameras may be further provided, and a detailed description thereof will be omitted hereinafter.

In this steer-by-wire steering device, since the steering wheel 101 and the wheel 119 are not mechanically connected, the steering shaft motor 120 may provide a reaction force to the driver. In addition, the pinion shaft motor 130 may provide steering force to the rack bar 111. The pinion shaft motor 130 and the rack bar 111 can be combined in various ways, and there is no limitation thereto.

Hereinafter, the motor for providing the steering reaction force to the steering wheel in the steer-by-wire steering device is described as a steering feedback motor (e.g., steering feedback actuator, SFA) or a steering reaction motor. In addition, the pinion shaft motor is described as an actuator that transmits the driver's steering intention to the vehicle wheels and moves the wheels, and may be referred to as a steering motor (e.g., road wheel actuator, RWA).

Since the steer-by-wire (SbW) steering device has no mechanical connection between the steering wheel and the rack bar, there may be difficult to physically control the steering of the vehicle if a failure occurs in the related system such as the electronic control unit.

Therefore, it is required the technology for providing stability in the SbW steering device. Accordingly, various technologies for establishing system redundancy are being proposed to cope with various failure situations.

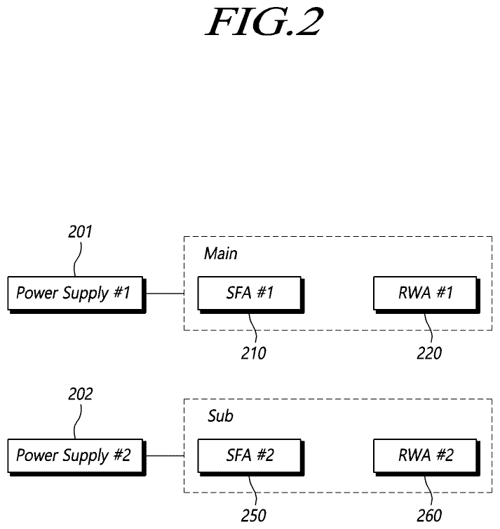

Regarding system redundancy, it will be described in detail with reference to FIG. 2.

FIG. 2 is a diagram for explaining the operation of the steer-by-wire steering device.

Referring to FIG. 2, the steer-by-wire steering device may be composed of a main system and a sub system or an auxiliary system. Since the steer-by-wire steering device is constructed with a main system and a sub system, the steer-by-wire steering device can perform operations even if a problem occurs in any one of the systems.

For example, the main system may include a first steering reaction motor (SFA #1) 210 and a first steering motor (RWA #1) 220 for providing steering reaction force. The first steering reaction motor 210 may provide steering reaction force to a steering wheel. The first steering motor 220 may provide steering force to a driving shaft.

The sub system or the auxiliary system may include a second steering reaction motor (SFA #2) 250 for providing steering reaction force and a second steering motor (RWA #2) 260. The second steering reaction motor 250 may provide steering reaction force to a steering wheel. The second steering motor 260 may provide steering force to a driving shaft.

Here, the first steering reaction motor 210 and the second steering reaction motor 250 may be configured to be separated as different physical motors. Alternatively, the first steering reaction motor 210 and the second steering reaction motor 250 may be configured to provide power as one motor in the form of dual windings, respectively. For example, the first steering motor 220 and the second steering motor 260 can form a dual winding structure that constructs a winding and inverter structure in one motor, respectively.

Similarly, the first steering motor 220 and the second steering motor 260 may be configured as separate physical motors. Alternatively, the first steering motor 220 and the second steering motor 260 may be configured to provide power as a single motor in the form of dual windings, respectively. For example, the first steering motor 220 and the second steering motor 260 may be configured as dual windings that each construct a winding and inverter structure in a single motor, respectively.

That is, the main system and the sub system may be physically configured as separate motors. Alternatively, the main system and the sub system can be configured as a dual winding system in one motor to perform redundancy.

Meanwhile, in terms of providing steering force and reaction force, the steer-by-wire steering device can be constructed in various ways as needed.

For example, the main system and the sub system may cooperate to provide normal output. For example, the first steering reaction force motor 210 may provide 50% output and the second steering reaction force motor 250 may provide 50% output, thereby providing 100% output in a normal state. Similarly, the first steering motor 220 may provide 50% output and the second steering motor 260 may provide 50% output, so that 100% output may be provided in normal conditions.

As another example, a redundant system may be constructed in which the main system provides 100% output in normal conditions, but the sub system provides 50 to 100% output when an abnormality occurs in the main system.

Meanwhile, the power supply system for supplying power to the main system and the sub system may also require redundancy. For example, power supply #1 201 may be constructed to supply power to the main system, and power supply #2 may be constructed to supply power to the sub system.

Accordingly, it is possible to secure the stability through an appropriate redundancy structure not only in the case of a motor system failure but also in the case of a power system failure.

The steer-by-wire steering device described above is an exemplary structure, and various structures such as a triple redundancy structure, a power sharing structure, and a structure that dualize only RWA can also be applied to this embodiment.

The steer-by-wire steering device has the advantage of securing vehicle space by omitting the mechanical connection structure, but it may also have the disadvantage of complicating the redundancy structure for securing stability. Therefore, a more efficient system is required while securing stability by constructing a redundancy structure.

For example, in the case of redundancy of the entire system from the power supply, double the resource is required in terms of space and cost. In this respect, the present disclosure proposes a steer-by-wire steering device, a power supply system, and a vehicle including the same capable of efficiently securing the stability.

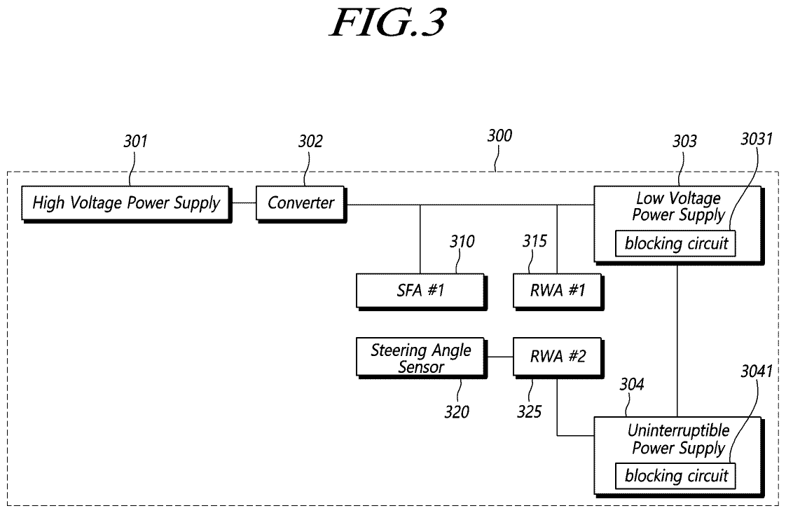

FIG. 3 is a diagram for explaining a power supply system according to one embodiment.

Referring to FIG. 3, a power supply system 300 for supplying power to a steer-by-wire steering device 310, 315, 320 and 325 including a main system and an auxiliary system, the power supply system, the power supply system 300 may include a high voltage power supply 301, a converter 302 configured to convert the voltage of the high voltage power supply into an operating voltage, a low voltage power supply 303, and an uninterruptible power supply 304 for receiving power from the low voltage power supply and supplying the power to the auxiliary system of the steer-by-wire steering device.

For example, a steer-by-wire steering device may include a main system and an auxiliary system. The main system may include a steering reaction motor 310 for providing a steering reaction force and a first steering motor 315 for providing a steering force. The auxiliary system may include a steering angle sensor 320 for detecting a steering angle of a steering wheel and a second steering motor 325 for providing a steering force.

The steering reaction motor 310 is configured to provide steering reaction force when the driver performs steering operation using the steering wheel, and may have a low possibility of being directly involved in performing the steering operation. Therefore, the steering reaction motor 310 may be configured only on the main system. However, if the steering reaction motor 310 fails, a problem may occur in a torque angle sensor connected thereto. The torque angle sensor may detect the steering force of the driver and steering angle.

Therefore, instead of duplicating the steering reaction motor 310, the auxiliary system may be configured to include a steering angle sensor 320 so that, when a problem occurs in the main system, the steering angle can be detected through the auxiliary system so as to perform an emergency steering operation of the vehicle. Here, the steering angle sensor 320 is exemplary, and a torque angle sensor may be configured instead of the steering angle sensor 320. That is, there is no limitation on the steering angle sensor 320 as long as it can detect the driver's steering angle.

The steering motor 315 and 325 may be a motor capable of directly applying steering force to a driving shaft of the vehicle. Accordingly, the steering motor may be configured as redundant since it may be difficult to provide steering force in the event of a failure.

Meanwhile, in configuring the power supply system 300, the power supply structure is also important. In particular, if a high voltage power supply 301 is utilized, the converter 302 for lowering the voltage into an operating voltage may be an expensive device and its size may become very large depending on the power supply voltage. Therefore, there may not be efficient to duplicate or dualize such a device.

In this regard, the structure of the power supply system 300 of the steer-by-wire steering device will be described.

The power supply system 300 may include one high voltage power supply 301 and one converter 302 for converting a high voltage into an operating voltage. For example, the high voltage power supply 301 may be a power supply device that supplies a high voltage of 800 V or higher. As an example, the high voltage power supply may be a battery of an electric vehicle. The converter 302 may lower the supplied high voltage to an operating voltage. The operating voltage may be set in various ways depending on the vehicle, and there is no limitation thereto. As an example, the operating voltage may be 12 V, 24 V, or 48 V. The operating voltage may be supplied to various components in the vehicle.

The low voltage power supply 303 may store and supply the operating voltage. The low voltage power supply 303 may stably supply the operating voltage in the vehicle, and may temporarily supply the operating voltage if a failure occurs in the high voltage power supply 301 or the converter 302. For example, the low voltage power supply 303 may be configured as a battery or a capacitor, etc.

The main system may be configured to operate by receiving an operating voltage from either the converter 302 or the low voltage power supply 303.

As an example, the main system may operate by receiving an operating voltage supplied through the converter 302 in a normal situation.

As another example, the main system may be configured to operate by receiving an operating voltage from the low voltage power supply 303 when at least one of the high voltage power supply 301 or the converter 302 is in a failure state. In this case, since the operating voltage application time of the low voltage power supply 303 may be limited, and the operating voltage application of the low voltage power supply 303 may be used to perform an emergency steering operation of the vehicle.

The auxiliary system may be supplied with power through an uninterruptible power supply 304 that receives power from the low voltage power supply 303.

For example, the second steering motor 325 may be connected to the uninterruptible power supply 304 to receive an operating voltage. The steering angle sensor 320 may be configured to receive power through the second steering motor 325.

For example, the auxiliary system may be configured to receive power for a preset time from the uninterruptible power supply 304 if the low voltage power supply 303 has a failure. Meanwhile, in order to prevent a short circuit problem in the power system, the low voltage power supply 303 and the uninterruptible power supply 304 may each be configured to include a blocking circuit (3031, 3041) configured to block current flowing therethrough. The blocking circuit may mean a circuit breaker, and may prevent power leakage when a short circuit problem occurs. For example, the blocking circuit may be configured as an electronic fuse (eFuse) circuit or a switch circuit.

The power supply system 300 enables the vehicle to be safely controlled for steering even when an abnormality or a failure occurs in any one of the main system, auxiliary system, and power supply line.

For example, the power supply system 300 may consist of only a high voltage power supply 310, a converter 302, and a low voltage power supply 303, thereby providing efficiency in terms of vehicle space and cost.

As another example, the power supply system 300 may provide the steering power necessary for the vehicle to move to a safe zone, such as a shoulder, by using the power of the low voltage power supply 303 and the uninterruptible power supply 304 when an abnormality occurs in the high voltage power supply 301 or the converter 302.

As another example, the power supply system 300 may provide the steering power necessary for the vehicle to move to a safe zone by using the power of the uninterruptible power supply 304 even when an abnormality occurs in the low voltage power supply 303.

As another example, the power supply system 300 may continuously operate the vehicle steering operation as the high voltage power supply 301 and the low voltage power supply 303 stably supply power even when an abnormality occurs in the uninterruptible power supply 304.

As another example, the power supply system 300 may acquire steering angle information through the steering angle sensor 320 of the auxiliary system even when the steering reaction motor 310 fails, thereby enabling stable vehicle steering operation.

As another example, the power supply system 300 may enable vehicle steering operation through the sub system or an auxiliary system even when a failure occurs in the main system.

As another example, the power supply system 300 may secure stability by providing a blocking circuit (3031, 3041) to each of the low voltage power supply 303 and the uninterruptible power supply 304 in preparation for a short circuit of the main system or the low voltage power supply 303. Of course, the main system and the low voltage power supply 303 can be protected through the blocking circuit even when the auxiliary system or the uninterruptible power supply 304 has a failure.

In this way, the power supply system 300 according to the present embodiment can provide stable steering operation of the vehicle even in various failure situations while being efficient.

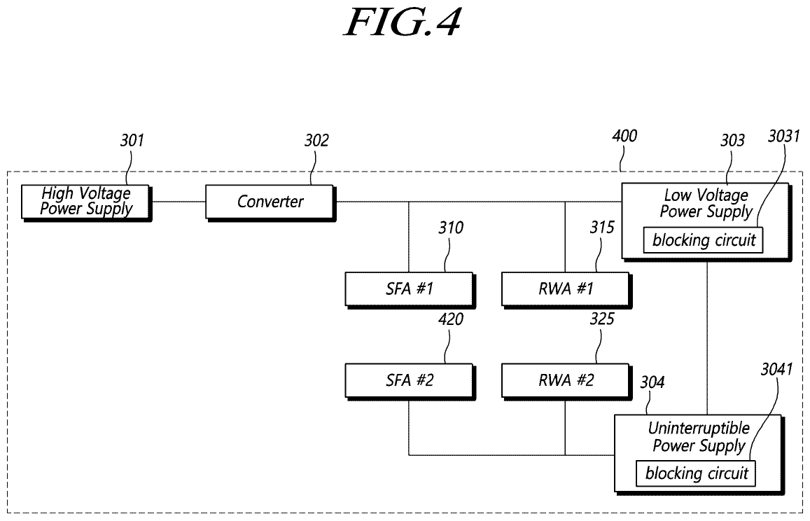

FIG. 4 is a diagram for explaining a power supply system according to another embodiment.

Referring to FIG. 4, the power supply system 400 may be also configured such that a second steering reaction motor 420 instead of a steering angle sensor is included in the auxiliary system. If the second steering reaction motor 420 is included in the auxiliary system, there may be provided a more stable redundancy structure through the auxiliary system.

The power supply system 400 may be configured similarly to the structure of the power supply system 300 described with reference to FIG. 3.

For example, a high voltage power supply 301, a converter 302 connected thereto to convert voltage into an operating voltage, a low voltage power supply 303, an uninterruptible power supply 304, and a main system 310 and 315 may be configured identically to the structure of FIG. 3. Therefore, there will be omitted a description of these devices and functions.

The power supply system 400 has a difference in that the auxiliary system includes the second steering reaction motor 420 and the second steering motor 325.

Due to this difference, the second steering reaction motor 420 may be configured to be directly connected to the uninterruptible power supply 304. In the case of the steering angle sensor 320, power may be supplied through the second steering motor 325, but the second steering reaction motor 420 may be connected to the uninterruptible power supply 304 to receive power for motor driving.

The structure of the power supply system 400 may similarly provide steering operation of the vehicle in various failure situations described above. In particular, in the case where the main system fails or the first steering reaction motor 310 fails, the steering reaction force may be provided using the second steering reaction motor 420 of the auxiliary system.

The power supply system structure as above may provide a stable and efficient power to the steer-by-wire device. In addition, the present disclosure may provide an effect of the space efficiency, and also may provide the effect of lowering costs.

Hereinafter, it will be described again the configuration of the steer-by-wire steering device and the vehicle including the same according to the power supply system described above. However, some contents may be omitted, if necessary, to prevent unnecessary duplication of explanation. The omitted contents may be applied to the contents described above.

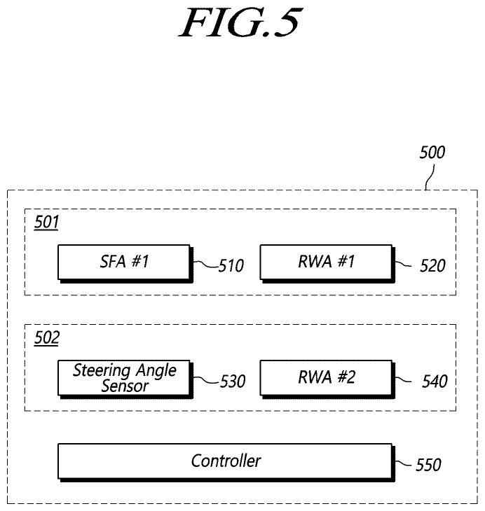

FIG. 5 is a diagram for explaining a configuration of a steer-by-wire steering device according to another embodiment.

Referring to FIG. 5, a steer-by-wire steering device 500 may include a main system 501 including a steering reaction motor 510 configured to provide a steering reaction force and a first steering motor 520 configured to provide a steering force, an auxiliary system 502 including a steering angle sensor 530 configured to detect a steering angle of a steering wheel and a second steering motor 540 configured to provide a steering force, and a controller 550 for controlling the main system and the auxiliary system.

As described above, the main system 501 may be configured to receive an operating voltage from a low voltage power supply or a converter configured to convert a voltage of a high voltage power supply to the operating voltage. The auxiliary system 502 may be configured to receive an operating voltage through an uninterruptible power supply that receives power from a low voltage power supply. For example, the steering angle sensor 530 may be configured to receive power through the second steering motor.

For example, the main system 501 may receive an operating voltage from the converter when the high voltage power supply and the converter are in a normal status, and may operate by receiving an operating voltage from the low voltage power supply when at least one of the high voltage power supply and the converter is in a failure state.

For another example, the auxiliary system 502 may be configured to receive power for a preset period of time from the uninterruptible power supply when the low voltage power supply is in a failure state. In this case, the steering angle sensor 530 may also receive power supplied by the uninterruptible power supply through the second steering motor 540.

Alternatively, the auxiliary system 502 may be configured to include a second steering reaction motor instead of the steering angle sensor 530, as shown in FIG. 4. In this case, the second steering reaction motor may receive power from the uninterruptible power supply. The uninterruptible power supply may be configured in two units to supply power to the second steering reaction motor and the second steering motor 540.

Meanwhile, the controller 550 may control the main system 501 and the auxiliary system 502 to move the vehicle to a safe zone based on an amount of power capable of being supplied by the low voltage power supply and the uninterruptible power supply when at least one of the high voltage power supply and the converter is in a failure state.

For example, in the case where the high voltage power supply or the converter has a failure, the controller 550 may temporarily support the steering operation of the vehicle using the low voltage power supply so as for the vehicle to move to a safe zone.

The controller 550 may control the main system 501 and the auxiliary system 502 to move the vehicle to a safe zone based on an amount of power that can be supplied by the uninterruptible power supply when the low voltage power supply is in a failure state. Since the amount of power available from the uninterruptible power supply is limited, the temporary steering power may be provided to move the vehicle to a safe zone.

The controller 550 may control the first steering motor 520 and the second steering motor 540 using the steering angle acquired by the steering angle sensor 530 when the steering reaction motor 510 is a failure state. In this case, the steering reaction force provided to the driver may be limited, but the steering operation of the vehicle may be supported by detecting the steering angle and/or steering torque. For the steering torque detection, the steering angle sensor 530 may acquire not only the steering angle but also the steering torque information. For example, the steering angle sensor 530 may be configured as a steering torque sensor.

In addition, the power supply operation and detailed configuration for the steer-by-wire steering device 500 are omitted since they have been described with reference to FIGS. 3 and 4.

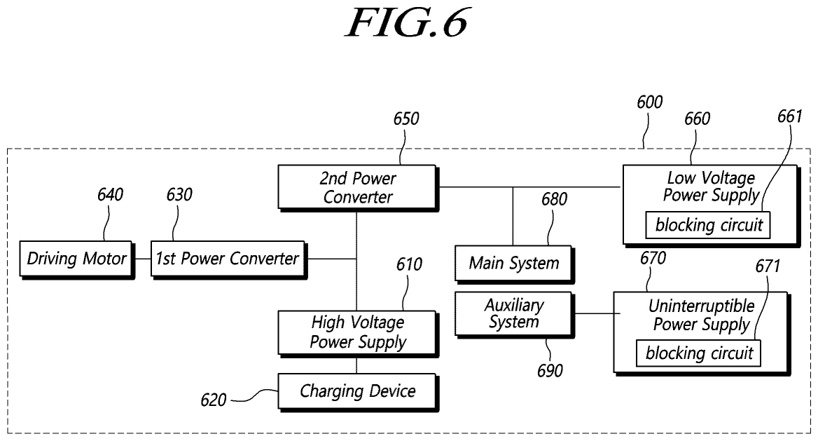

FIG. 6 is a diagram for explaining a vehicle configuration according to another embodiment.

Referring to FIG. 6, a vehicle 600 may include a high voltage power supply 610, a motor 640 configured to receive power from the high voltage power supply 610, a second power converter 650 as a converter 650 configured to convert the voltage of the high voltage power supply 610 into an operating voltage, a low voltage power supply 660, a steer-by-wire steering device including a main system 680 and an auxiliary system 690, and an uninterruptible power supply 670 for receiving power from the low voltage power supply 660 and supplying the power to the auxiliary system 690 of the steer-by-wire steering device.

In addition, the vehicle 600 may further include a charging device 620 for charging the high voltage power supply 610 and a first power converter 630 for applying a voltage of the high voltage power supply 610 to the driving motor 640.

Here, the vehicle 600 may be an electric vehicle. The electric vehicle may be a vehicle that provides driving force using electricity. The driving motor 640 may be a motor for providing driving force to the front and/or rear wheels of the vehicle 600 to move the vehicle. The driving motor 640 may operate at high voltage, and may be equipped with a second power converter 650 and a first power converter 630 different from the second power converter 650. Here, the second power converter 650 refers to the converter described above.

The main system 680 of the steer-by-wire steering device may be configured to operate by receiving an operating voltage from the second power converter 650 or the low voltage power supply 660.

For example, the main system 680 of the steer-by-wire steering device may be configured to operate by receiving an operating voltage from the low voltage power supply 660 when at least one of the high voltage power supply 610 or the second power converter 650 is in a failure state.

For example, the auxiliary system 690 may be configured to receive power from the uninterruptible power supply 670 for a preset period of time when the low voltage power supply 660 is in a failure state.

The low voltage power supply 660 and the uninterruptible power supply 670 may be each configured to include a blocking circuit(661, 671) configured to block current flowing therethrough. The blocking circuit may be configured as an eFuse circuit or a switch circuit. The blocking circuit may be an electronic fuse circuit including at least one switch element. Even when the main system 680 or the auxiliary system 690 is short-circuited, it is possible to prevent the power leakage through circuit blocking by using the blocking circuit.

For the specific operation according to the failure of each device in the vehicle 600, there may be applied the configuration described with reference to FIG. 3. Therefore, the corresponding description will be omitted in order to avoid redundant explanation.

In this way, the vehicle 600 according to the present disclosure can provide space optimization and cost reduction effects through an efficient steer-by-wire steering device and power supply system.

The steer-by-wire steering device, power supply system, and vehicle including the same described above can provide stable and efficient vehicle steering operation.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A power supply system for supplying power to a steer-by-wire steering device including a main system and an auxiliary system, the power supply system comprising:
a high voltage power supply;
a converter configured to convert a voltage of the high voltage power supply into an operating voltage;
a low voltage power supply; and
an uninterruptible power supply configured to receive power from the low voltage power supply and supply the power to the auxiliary system of the steer-by-wire steering device.

2. The power supply system of claim 1, wherein:
the main system of the steer-by-wire steering device includes a steering reaction motor configured to provide a steering reaction force and a first steering motor configured to provide a steering force,
the auxiliary system of the steer-by-wire steering device includes a steering angle sensor configured to detect a steering angle of a steering wheel and a second steering motor configured to provide the steering force.

3. The power supply system of claim 2, wherein the steering angle sensor is configured to receive power through the second steering motor.

4. The power supply system of claim 1, wherein the main system of the steer-by-wire steering device is configured to operate by receiving the operating voltage from the converter or the low-voltage power supply.

5. The power supply system of claim 4, wherein the main system of the steer-by-wire steering device is configured to operate by receiving the operating voltage through the low voltage power supply when at least one of the high voltage power supply or the converter is in a failure state.

6. The power supply system of claim 1, wherein the auxiliary system of the steer-by-wire steering device is configured to be supplied with the power from the uninterruptible power supply when the low voltage power supply is in a failure state.

7. The power supply system of claim 1, wherein the low voltage power supply and the uninterruptible power supply are each configured to include a blocking circuit configured to block current flowing therethrough.

8. A steer-by-wire steering device comprising:
a main system including a steering reaction motor configured to provide a steering reaction force and a first steering motor configured to provide a steering force;
an auxiliary system including a steering angle sensor configured to detect a steering angle of a steering wheel and a second steering motor configured to provide the steering force; and
a controller configured to control the main system and the auxiliary system,
wherein the main system is configured to receive an operating voltage from a low voltage power supply or a converter configured to convert a voltage of a high voltage power supply to the operating voltage, and
wherein the auxiliary system is configured to receive the operating voltage from an uninterruptible power supply configured to receive power from the low voltage power supply.

9. The steer-by-wire steering device of claim 8, wherein the steering angle sensor is configured to receive power through the second steering motor.

10. The steer-by-wire steering device of claim 8, wherein the main system is configured to:
receive the operating voltage from the converter when the high voltage power supply and the converter are in a normal status, and
receive the operating voltage from the low voltage power supply when at least one of the high voltage power supply and the converter is in a failure state.

11. The steer-by-wire steering device of claim 8, wherein the auxiliary system is configured to be supplied with the power from the uninterruptible power supply when the low voltage power supply is in a failure state.

12. The steer-by-wire steering device of claim 8, wherein the controller is configured to control the main system and the auxiliary system to move a vehicle to a safe zone based on an amount of power capable of being supplied by the low voltage power supply and the uninterruptible power supply when at least one of the high voltage power supply and the converter is in a failure state.

13. The steer-by-wire steering device of claim 8, wherein the controller is configured to control the main system and the auxiliary system to move a vehicle to a safe zone based on an amount of power capable of being supplied by the uninterruptible power supply when the low voltage power supply is in a failure state.

14. The steer-by-wire steering device of claim 8, wherein the controller is configured to control the first steering motor and the second steering motor using the steering angle detected by the steering angle sensor when the steering reaction motor is a failure state.

15. A vehicle comprising:
a high voltage power supply;
a motor configured to receive power from the high voltage power supply;
a converter configured to convert a voltage of the high voltage power supply into an operating voltage;
a low voltage power supply;
a steer-by-wire steering device including a main system and an auxiliary system; and
an uninterruptible power supply configured to receive power from the low voltage power supply and supply the power to the auxiliary system of the steer-by-wire steering device.

16. The vehicle of claim 15, wherein the main system of the steer-by-wire steering device is configured to operate by receiving the operating voltage from the converter or the low voltage power supply.

17. The vehicle of claim 16, wherein the main system of the steer-by-wire steering device is configured to operate by receiving the operating voltage through the low voltage power supply when at least one of the high voltage power supply or the converter is in a failure state.

18. The vehicle of claim 15, wherein the auxiliary system of the steer-by-wire steering device is configured to be supplied with the power from the uninterruptible power supply when the low voltage power supply is in a failure state.

19. The vehicle of claim 15, wherein the low voltage power supply and the uninterruptible power supply are each configured to include a blocking circuit configured to block current flowing therethrough.

20. The vehicle of claim 19, wherein the blocking circuit comprises an electronic fuse circuit including at least one switch element.
